(19) United States
(12) Patent Application Publication
(10) Pub. No.: US 2023/0177113 A1
(43) Pub. Date: Jun. 8, 2023

(54) PRIVACY-PRESERVING CLASS LABEL STANDARDIZATION IN FEDERATED LEARNING SETTINGS

(71) Applicant: International Business Machines Corporation, Armonk, NY (US)

(72) Inventors: Shonda Adena Witherspoon, Yorktown Heights, NY (US); Ramasuri Narayanam, Bangalore (IN); Hima Patel, Bengaluru (IN); Sameep Mehta, Bangalore (IN)

(21) Appl. No.: 17/540,660

(22) Filed: Dec. 2, 2021

(51) Int. Cl. G06K 9/62; G06N 20/00

(52) U.S. Cl. CPC G06K 9/6256; G06K 9/628; G06K 9/6215; G06N 20/00

(57) ABSTRACT

Methods, systems, and computer program products for privacy-preserving class label standardization in federated learning settings are provided herein. A computer-implemented method includes determining, using one or more data privacy-preserving techniques, a signature for each of one or more classes of data for each of multiple client devices within a federated learning environment; identifying one or more signature matches across at least a portion of the multiple client devices; generating one or more class labels for the one or more classes of data associated with the one or more signature matches; labeling, across the at least a portion of the multiple client devices, the one or more classes of data associated with the one or more signature matches with the one or more generated class labels; and performing one or more automated actions based at least in part on the one or more labeled classes of data.

### BACKGROUND

The present application generally relates to information technology and, more particularly, to data processing. For example, consider the setting of federated learning (FL), wherein different clients possess their own private data which cannot be shared with others (e.g., due to privacy constraints). In this setting, a need may arise to carry out a machine learning-based task or a business intelligence task which can require consistent class labels across nodes such that the model can train effectively by taking diverse examples from the different nodes belonging to the same class. As used herein, a node refers to a participating client in a federated learning setting, while a class refers to a set of labels in supervised machine learning.

However, conventional federated learning approaches typically fail to generate consistent class labels, and as such, multiple issues can occur. Such issues can include, for example, a model considering the same class as two different classes and attempting (at the expense of time, resources, and/or model accuracy) to learn class separations. Such issues can also include, for instance, problems during inference phases.

### SUMMARY

In at least one embodiment, techniques for privacy-preserving class label standardization in federated learning settings are provided. An example computer-implemented method includes determining, using one or more data privacy-preserving techniques, a signature for each of one or more classes of data for each of multiple client devices within a federated learning environment, and identifying one or more signature matches across at least a portion of the multiple client devices. The method also includes generating one or more class labels for the one or more classes of data associated with the one or more signature matches, labeling, across the at least a portion of the multiple client devices, the one or more classes of data associated with the one or more signature matches with the one or more generated class labels, and performing one or more automated actions based at least in part on the one or more labeled classes of data.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an example embodiment of the invention;

FIG. 2 is a flow diagram illustrating techniques according to an example embodiment of the invention;

FIG. 3 is a system diagram of an example computer system on which at least one embodiment of the invention can be implemented;

FIG. 4 depicts a cloud computing environment according to an example embodiment of the invention; and

FIG. 5 depicts abstraction model layers according to an example embodiment of the invention.

### DETAILED DESCRIPTION

As described herein, at least one embodiment includes implementing federated learning settings to standardize class labels of individual client private data for supervised machine learning settings without violating privacy constraints. Such an embodiment can include identifying a unique signature for each class on the client side, and identifying and matching signatures at the server side to identify the same class across different nodes. Additionally, in such an embodiment, alignment is achieved by server mapping the class signatures and providing one or more new labels to each class, wherein such labels are then communicated to each node/client and used as the label(s) for machine learning training. As used in this context, signatures refer to patterns (e.g., significant patterns) associated with data points belonging to a particular class label. To capture these signatures, at least one embodiment includes constructing a graph using data points belonging to the same class. An example of signatures can include the embeddings of whole graphs wherein each whole graph represents similarities among the data points of each class label.

Accordingly, one or more embodiments include standardizing class labels of individual client private data in federated learning settings for supervised machine learning tasks. Such an embodiment includes learning one or more signatures for each class that capture(s) the generality of the class, and transferring such signatures to a given server, wherein the server computes and/or determines signature similarity to identify classes which are the same from different nodes but may have different labels. Additionally, in such an embodiment, the server can maintain a mapping of class labels from different nodes and can share a new label for each class to the nodes with each signature. Further, at every node, the client receives the new label for each signature and adds it as secondary label which can be used for the training at least one related machine learning model.

As also detailed herein, at least one embodiment includes formulating one or more operations to learn specific class characteristics and matching classes across nodes in a federated context, without passing actual data or the labels. As such, with the increased development of hybrid cloud systems and infrastructure, federated learning scenarios within a single enterprise (due, for example, to compliance constraints, etc.) as well as across multiple-enterprises (due, for example, to privacy constraints, compliance constraints, etc.) are also increasing. Accordingly, class label standardization in federated learning settings, as implemented in one or more embodiments, avoids training with incorrect samples and thereby enables accurate learning of global models in federated learning contexts. Further, such embodiments include allowing machine learning tasks and business intelligence tasks in federated learning settings to be carried out by multiple clients while keeping corresponding data private.

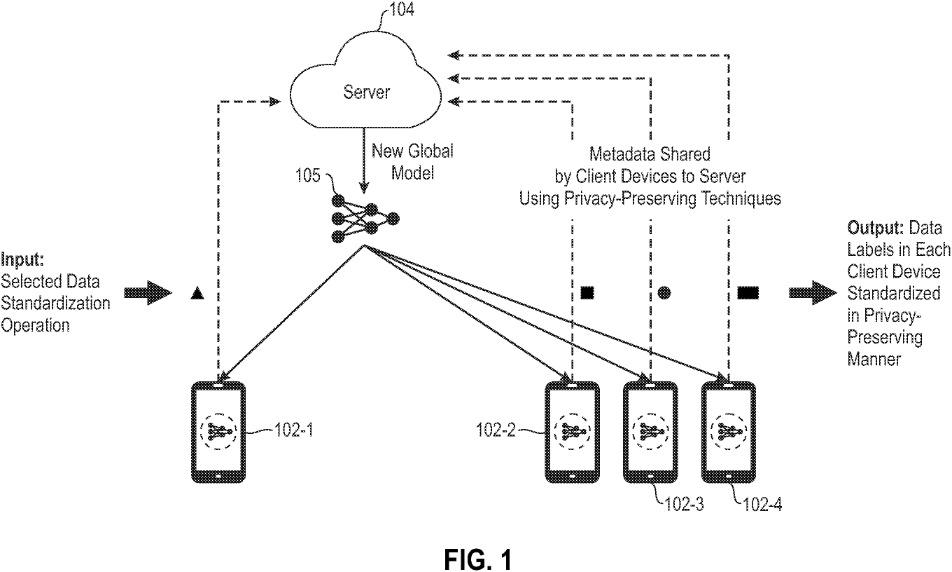

FIG. 1 is a diagram illustrating system architecture, according to an embodiment of the invention. By way of illustration, FIG. 1 depicts example architecture, which includes client devices 102-1, 102-2, 102-3 and 102-4 (collectively referred to herein as client devices 102), as well as cloud server 104, for implementing a data standardization operation (Data-Std-Op) that includes class label standardization. As also depicted in FIG. 1, the arrows (dotted lines) coming from the client devices 102 to the cloud server 104 indicate metadata being shared to the cloud server 104. The shape icons (i.e., circle, triangle, square, and rectangle) represent the metadata at each unique client device (i.e., client devices 102-1, 102-2, 102-3 and 102-4). The new global model 105 being shared by the cloud server 104 with the devices 102 is shown with the solid line arrows directed from the new global model icon 105 representing the model available at the cloud server 104.

At each individual client device, the client devices 102 compute the number of different class labels associated with the client’s data, and categorize data records of the client according to class label(s). If the number of class labels is m, then at least one embodiment includes clustering the data records into m groups. Additionally, such an embodiment can include assuming that the number of class labels m is the same across all client devices 102.

For each of these m groups, one or more embodiments includes determining a portion of representative data records using one or more strategies. For example, let Dᵢ = (Dil, Dᵢ₂, ..., Dim), such that Diⱼ is a subset of representative data records of group/class j of client i. Such an embodiment can also include computing one or more embedding vectors of each data record of Diⱼ in the vector Di, and sharing the same with the cloud server 104. At least one embodiment can include assuming that all client devices 102 map such representative data records to the same vector space (as directed by the cloud server 104).

Referring again to FIG. 1, at the cloud server 104, upon receiving the K embedding vectors (D_1, D_2, ..., D_K) from all clients devices 102, the cloud server 104 performs the following computation to derive the set of standardized labels. Note also that the number of groups of embedding vectors (received from all client devices 102) is represented as K*m. Accordingly, for each pair of ((K*m) * ((K*m) - 1) / 2) groups of embedding vectors, the cloud server 104 computes the similarity between their respective embedding vectors by computing the average distance among them. Then, in one or more embodiments, the cloud server 104 determines the top K*m pairs with high similarity scores (i.e., by having less average distance).

Unwrapping the above K*m pairs of groups of embedding vectors would indicate which of the m groups in client i are mapped to which m groups in client j. Accordingly, by way merely of example, assume that group A in client i is similar to group B in client j, and group B in client j is similar to group C in client k. By transitivity, such a determination implies that these three groups, A, B, and C, belong to the same class label. The above-outlined similarity-driven transitivity property determination allows one or more embodiments to determine m different clusters such that each cluster has K similar groups. Also, in each of these m clusters, at least one embodiment includes assigning the same label for all of the K groups within it. Thus, such an embodiment includes attaining m different labels that are consistent across all of the clients.

As such, in one or more embodiments, these K*m pairs define the mapping of correct class labels among the clients, as the feature vectors corresponding to the same class labels are also expected to be very similar, in general.

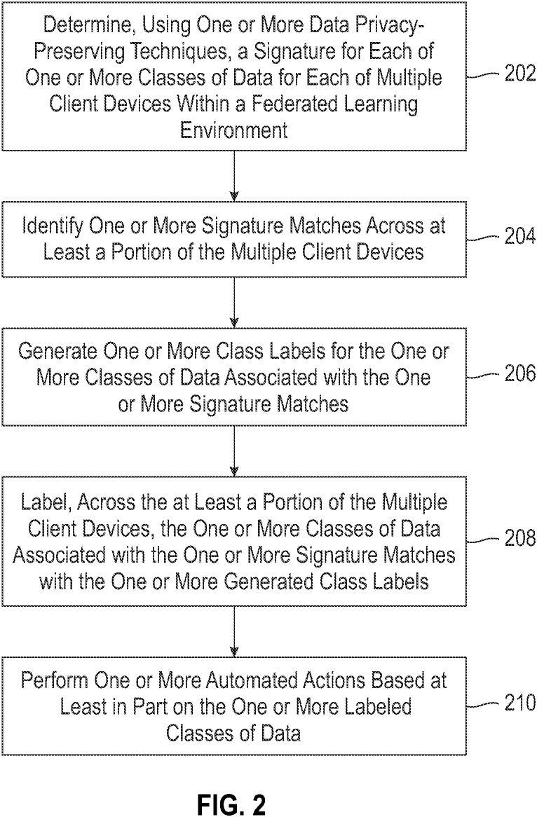

FIG. 2 is a flow diagram illustrating techniques according to an embodiment of the present invention. Step 202 includes determining, using one or more data privacy-preserving techniques, a signature for each of one or more classes of data for each of multiple client devices within a federated learning environment. With respect to such data privacy-preserving techniques, one or more embodiments include learning one or more signatures for each class that capture the generality of the class, and transferring the signature(s) to the server, wherein the server computes and identifies signature similarity to identify one or more classes which are the same from different nodes and/or may have different labels. Additionally, in such an embodiment, the server maintains a mapping of class labels from different nodes and shares a new label for each class to the nodes with each signature. At every node, the client receives the new label for each signature and adds the new label as a secondary label that is used for training a machine learning model. In such an embodiment, the above-noted steps perform the task of class label standardization without breaching the privacy of the data owned by the clients. In this sense, such an embodiment includes and/or implements a privacy-preserving technique.

In at least one embodiment, determining includes computing a total number of different class labels associated with the data across the multiple client devices. Such an embodiment can also include clustering the data of each of the multiple client devices, according to class label, in a number of groups equal to the total number of different class labels, and computing embedding vectors of multiple items of data derived from the data of each of the multiple client devices.

Step 204 includes identifying one or more signature matches across at least a portion of the multiple client devices. In one or more embodiments, identifying one or more signature matches includes, for each pair of embedding vectors, computing a similarity value based at least in part on at least one distance value associated with the two embedding vectors. Such an embodiment can also include determining a given number of the embedding vector pairs having a similarity value above a given value, and identifying at least a portion of the one or more signature matches by unwrapping the given number of the embedding vector pairs, wherein unwrapping comprises determining which of the class labels of at least a first client device are mapped to which of the class labels of at least a second client device.

Step 206 includes generating one or more class labels for the one or more classes of data associated with the one or more signature matches. In at least one embodiment, generating the one or more class labels includes assigning, across the multiple client devices within the federated learning environment, a unique label for each respective one of the one or more classes of data associated with the one or more signature matches. Additionally or alternatively, generating the one or more class labels can include communicating the one or more generated class labels to each of the multiple client devices associated with the one or more classes of data associated with the one or more signature matches.

Step 208 includes labeling, across the at least a portion of the multiple client devices, the one or more classes of data associated with the one or more signature matches with the one or more generated class labels.

Step 210 includes performing one or more automated actions based at least in part on the one or more labeled classes of data. In at least one embodiment, performing one or more automated actions includes training one or more machine learning models using the one or more labeled classes of data. Such an embodiment can also include performing at least one machine learning-based operation within the federated learning environment using at least a portion of the one or more trained machine learning models.

In one or more embodiments, software implementing the techniques depicted in FIG. 2 can be provided as a service in a cloud environment.

It is to be appreciated that “model,” as used herein, refers to an electronic digitally stored set of executable instructions and data values, associated with one another, which are capable of receiving and responding to a programmatic or other digital call, invocation, or request for resolution based upon specified input values, to yield one or more output values that can serve as the basis of computer-implemented recommendations, output data displays, machine control, etc. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer.

The techniques depicted in FIG. 2 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

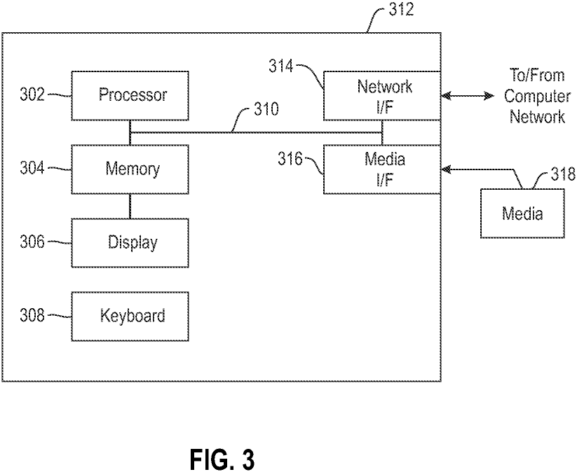

Additionally, an embodiment of the present invention can make use of software running on a computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 302. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that implementation of the teachings recited herein are not limited to a particular computing environment. Rather, embodiments of the present invention are capable of being implemented in conjunction with any type of computing environment now known or later developed.

For example, cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

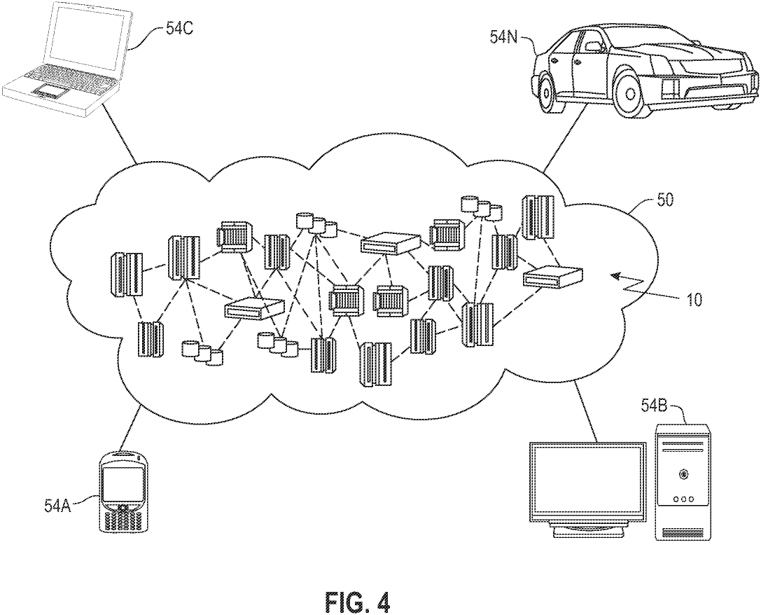

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

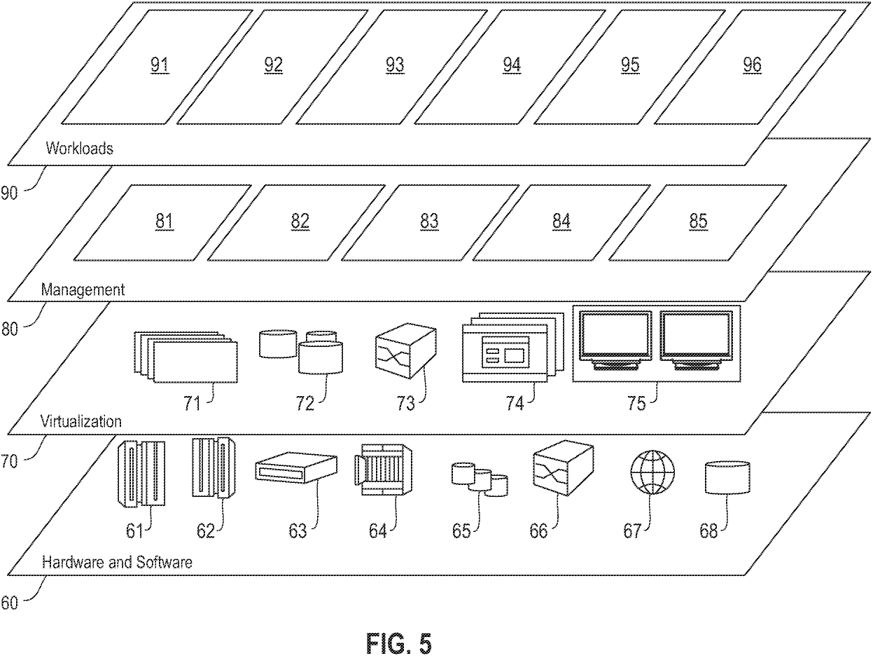

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and class label standardization 96, in accordance with the one or more embodiments of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, privacy-preserving class label standardization in federated learning settings.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
determining, using one or more data privacy-preserving techniques, a signature for each of one or more classes of data for each of multiple client devices within a federated learning environment;
identifying one or more signature matches across at least a portion of the multiple client devices;
generating one or more class labels for the one or more classes of data associated with the one or more signature matches;
labeling, across the at least a portion of the multiple client devices, the one or more classes of data associated with the one or more signature matches with the one or more generated class labels; and
performing one or more automated actions based at least in part on the one or more labeled classes of data;
wherein the method is carried out by at least one computing device.

2. The computer-implemented method of claim 1, wherein performing one or more automated actions comprises training one or more machine learning models using the one or more labeled classes of data.

3. The computer-implemented method of claim 2, wherein performing one or more automated actions comprises performing at least one machine learning-based operation within the federated learning environment using at least a portion of the one or more trained machine learning models.

4. The computer-implemented method of claim 1, wherein generating the one or more class labels comprises assigning, across the multiple client devices within the federated learning environment, a unique label for each respective one of the one or more classes of data associated with the one or more signature matches.

5. The computer-implemented method of claim 1, wherein generating the one or more class labels comprises communicating the one or more generated class labels to each of the multiple client devices associated with the one or more classes of data associated with the one or more signature matches.

6. The computer-implemented method of claim 1, wherein determining comprises computing a total number of different class labels associated with the data across the multiple client devices.

7. The computer-implemented method of claim 6, further comprising:
clustering the data of each of the multiple client devices, according to class label, in a number of groups equal to the total number of different class labels.

8. The computer-implemented method of claim 7, further comprising:
computing embedding vectors of multiple items of data derived from the data of each of the multiple client devices.

9. The computer-implemented method of claim 8, wherein identifying one or more signature matches comprises, for each pair of embedding vectors, computing a similarity value based at least in part on at least one distance value associated with the two embedding vectors.

10. The computer-implemented method of claim 9, further comprising:
determining a given number of the embedding vector pairs having a similarity value above a given value.

11. The computer-implemented method of claim 10, further comprising:
identifying at least a portion of the one or more signature matches by unwrapping the given number of the embedding vector pairs, wherein unwrapping comprises determining which of the class labels of at least a first client device are mapped to which of the class labels of at least a second client device.

12. The computer-implemented method of claim 1, wherein software implementing the method is provided as a service in a cloud environment.

13. A computer program product comprising a computer readable storage medium having program instructions embodied therewith, the program instructions executable by a computing device to cause the computing device to:
determine, using one or more data privacy-preserving techniques, a signature for each of one or more classes of data for each of multiple client devices within a federated learning environment;
identify one or more signature matches across at least a portion of the multiple client devices;
generate one or more class labels for the one or more classes of data associated with the one or more signature matches;
label, across the at least a portion of the multiple client devices, the one or more classes of data associated with the one or more signature matches with the one or more generated class labels; and
perform one or more automated actions based at least in part on the one or more labeled classes of data.

14. The computer program product of claim 13, wherein performing one or more automated actions comprises training one or more machine learning models using the one or more labeled classes of data.

15. The computer program product of claim 14, wherein performing one or more automated actions comprises performing at least one machine learning-based operation within the federated learning environment using at least a portion of the one or more trained machine learning models.

16. The computer program product of claim 13, wherein generating the one or more class labels comprises assigning, across the multiple client devices within the federated learning environment, a unique label for each respective one of the one or more classes of data associated with the one or more signature matches.

17. The computer program product of claim 13, wherein generating the one or more class labels comprises communicating the one or more generated class labels to each of the multiple client devices associated with the one or more classes of data associated with the one or more signature matches.

18. The computer program product of claim 13, wherein determining comprises:
computing a total number of different class labels associated with the data across the multiple client devices;
clustering the data of each of the multiple client devices, according to class label, in a number of groups equal to the total number of different class labels; and
computing embedding vectors of multiple items of data derived from the data of each of the multiple client devices.

19. The computer program product of claim 18, wherein identifying one or more signature matches comprises:
for each pair of embedding vectors, computing a similarity value based at least in part on at least one distance value associated with the two embedding vectors;
determining a given number of the embedding vector pairs having a similarity value above a given value; and
identifying at least a portion of the one or more signature matches by unwrapping the given number of the embedding vector pairs, wherein unwrapping comprises determining which of the class labels of at least a first client device are mapped to which of the class labels of at least a second client device.

20. A system comprising:
a memory configured to store program instructions; and
a processor operatively coupled to the memory to execute the program instructions to:
determine, using one or more data privacy-preserving techniques, a signature for each of one or more classes of data for each of multiple client devices within a federated learning environment;
identify one or more signature matches across at least a portion of the multiple client devices;
generate one or more class labels for the one or more classes of data associated with the one or more signature matches;
label, across the at least a portion of the multiple client devices, the one or more classes of data associated with the one or more signature matches with the one or more generated class labels; and
perform one or more automated actions based at least in part on the one or more labeled classes of data.
